(19) United States
(12) Patent Application Publication
(10) Pub. No.: US 2002/0171738 A1
(43) Pub. Date: Nov. 21, 2002

(54) Automobile-based video system, a substitution of traditional mirrors

(76) Inventor: Jingfeng Guan, Seattle, WA (US)

Correspondence Address: Jingfeng Guan, 6323 65th Ave N E #4701, Seattle, WA, 98115, US

(21) Appl. No.: 09/835,974

(22) Filed: Apr. 17, 2001

(51) Int. Cl. H04N 7/18

(52) U.S. Cl. 348/148; 348/143; 348/153; 348/159

(57) ABSTRACT

An automobile-based video system, a substitution of traditional mirrors, and of the type have four video cameras, one control unit, two control buttons and one display panel with three screens and two light indicators. The control unit receives input video streams, does NIGHT enhancement transform and then sends them to the screens in the display panel. The transform functions enhance the sight when the outside is dark or it is in the evening.

### BACKGROUND

1. Field of Invention

This invention relates to automobile mirrors, which are substituted by video system for better performance.

2. Description of Prior Art

Usually, automobiles have three mirrors, two side-view mirrors and one back-view mirror. Some automobiles may have more or less mirrors, depending on the special purpose. For example, some trucks have more than one mirror each side in order to see more space and wide angle. Today, when we drive, we have to use mirrors to see if there is a car or something at your right side or left side or your back of the car. For better view, there are some products, such as mirror with a sphere-mirror embedded, are developed in the mirror design.

There are many disadvantages of traditional mirrors:

(a). Side view mirrors have to be installed at proper places related to drivers.

(b) They (side-view mirrors) affect the art of automobile design. The automobile designers have to let the side-view mirrors stick out. As a whole, these two mirrors impact the beauty of body shapes of the automobiles.

(c) They increase the cross-section area that the automobiles will encounter when they are running. As the mirrors are not combined with body in the body shape design, the two side mirrors add more effective cross-area, which means that the automobiles have to use more power to overcome the force from air. This also means more cost to the gas expense.

(d) When drivers want to see the condition at the side of their automobiles, they have to turn their heads to see, which means that their eyes have to be away from the driving direction for a moment, maybe half one second. We all understand that this moment is a dangerous moment since drivers don't know what are happening during the short period of time while the automobiles are moving that way.

(e) We know that the mirrors are somehow small. Many times, drivers want to see more wider angle and more space, but the area of mirrors is limited. Indeed, some mirror products, such as mirror with sphere mirror embedded, can help to see wider, that is not enough.

### OBJECTS AND ADVANTAGE

Accordingly, there are several objects and advantages of the present invention:

(a). These mirror-functioning video cameras are not limited in place related to the drivers because drivers don't need to see them. In this case, they can be placed anywhere in theory. Regarding the scope of these video cameras, some optimized places can be found based on body designs.

(b) Automobile designers can combine the mirror-substituted video cameras with the art of body design of the automobiles. Because video cameras can be built very small nowadays, they can actually be placed in small places. They will not impact the body design of the automobiles. This will give designers more flexibility to optimize body shapes. They could be even invisible from the front if they are placed properly in the design.

(c) Since the video cameras are small, they will not contribute to the effective cross-section area of the automobiles. You can imagine that gas cost can be reduced.

(d) Since video cameras are used instead of mirrors, drivers don't need to turn their heads to see mirrors any more. They watch screens in front of them. The real time video stream on the screens show the conditions at left side, right side, and rear side. If a camera is placed towards forward, front side conditions can be seen too, even though drivers usually see forward directly through the front windows. Now drivers keeps their eyes ahead and they can know the conditions at their automobiles' left side, right side and rear side, as long as their front side.

(e) Since video cameras can be made with larger view angles, drivers can actually see more space. This will help drivers to see clearly and judge correctly under certain conditions.

### SUMMARY OF THE INVENTION

In accordance with the present invention a Automobile-based Video System, a substitution of traditional mirrors, comprises 4 video cameras, a display panel with three screens and two light indicators, a control unit with NIGHT enhancement functions front/rear-view video switch, a NIGHT button with NIGHT enhancement selection, a Front/Rear button and cables to connect them together as shown in FIG. 4.

### DESCRIPTION OF DRAWING FIGURES

There are totally 19 drawings in this application.

FIG. 1 shows the positioning of four video cameras in a car, one for front-view, one for rear-view and two for side-view.

FIG. 2 shows the view angle of the video cameras. The two video cameras turns a little outside to the operating position.

FIG. 3 shows another positioning solution. In this pattern, the two side-view cameras are placed further forward.

FIG. 4 shows the diagram how the system works.

FIG. 5 shows the display panel behind the wheel. There are three screens in the panel and on the top of the Front/Rear screen, there are two light indicators, one is used to indicate NIGHT mode on and the other is used to indicate the Front-view is on the Front/Rear screen. It is noticed that there are some free space above the left screen and right screen and below the front/rear screen. These places can be used to place some meters, such as gas meter, speed meter and millage meter, and some light indicators.

FIG. 6 shows the Control Unit.

FIG. 7 shows the Front/Rear button.

FIG. 8 shows the NIGHT button. There is an arrow which will specify the transform function or table used in the NIGHT enhancement mode. There are five mode, N1, N2, N3, N4 and N5. N1 gives slight enhancement and N5 gives largest enhancement if the button is pressed. If the button is not pressed, the Control Unit is operating in normal mode and there is not enhancement, which means that what is seen in the screens is what is obtained from the video cameras.

FIGS. 9 to 13 show the transform function curves of N1, N2, N3, N4 and N5 respectively.

FIG. 14 shows the transform table for each of the five transform functions. This lookup table is convenient for computer or hardware to implement.

### REFERENCE NUMBERS IN THE DRAWINGS

| | |
|---|---|
| 1. (left) side-view video camera | 2. front-view video camera |
| 3. rear-view video camera | 4. (right) side-view video camera |
| 5. body | 6. view angle of a video camera |
| 7. (left) side-view video camera | 8. (right) side-view video camera |
| 9. (left) side-view video camera as 1 or 7 | 10. (right) side-view video camera as 4 or 8 |
| 11. NIGHT button | 12. Front/Rear button |
| 13. NIGHT light indicator | 14. Front/Rear light indicator |
| 15. control unit | 16. display panel |
| 17. left-view screen | 18. front/rear-view screen |
| 19. right-view screen | 20. (left) side-view video stream input port |
| 21. (right) side-view video stream input port | 22. front-view video stream input port |
| 23. rear-view video stream input port | 24. NIGHT button input port |
| 25. Front/Rear button input port | 26. Front/Rear light indicator output |
| 27. NIGHT light indicator output | 28. right-view screen video stream output |
| 29. front/rear-view screen video stream output | 30. left-view screen video stream output |
| 31. button of the Front/Rear button | 32. base of the Front/Rear button |
| 33. button of the NIGHT button | 34. base of the NIGHT button |
| 35. arrow indicator on the NIGHT button | 36. icon of a NIGHT enhancement function |
| 37. no enhancement as reference in the plot | 38. N1 NIGHT enhancement curve |
| 39. N2 NIGHT enhancement curve | 40. N3 NIGHT enhancement curve |
| 41. N4 NIGHT enhancement curve | 42. N5 NIGHT enhancement curve |

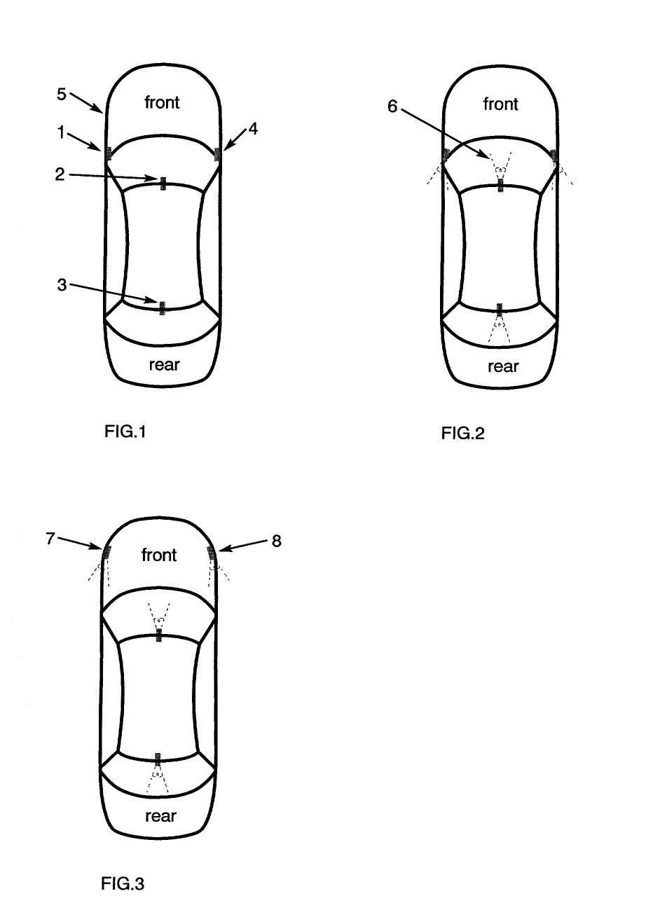

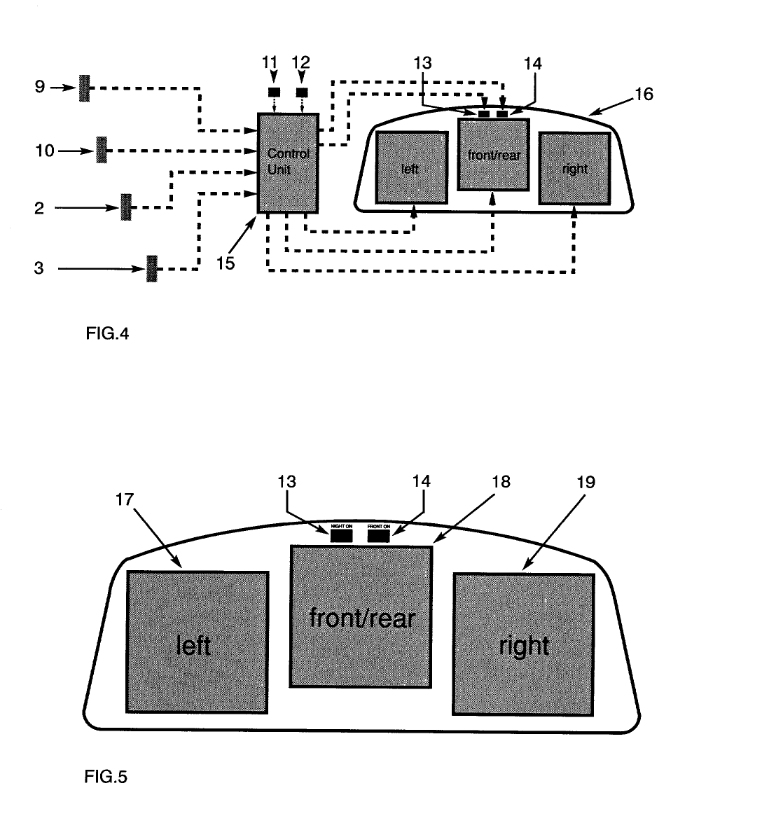

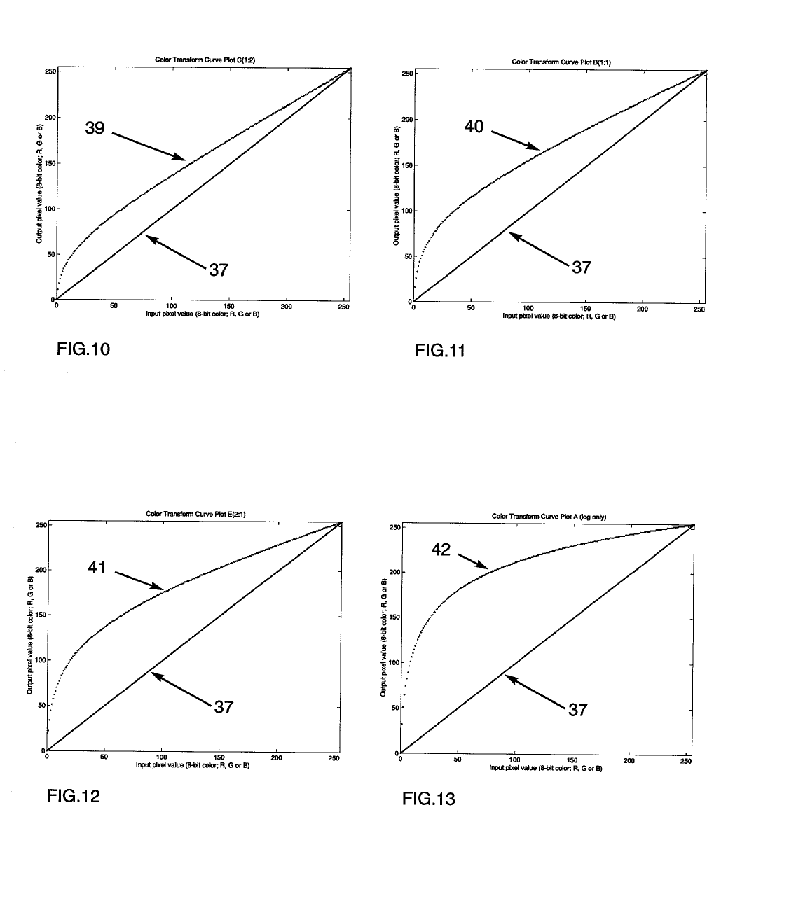

### DETAIL DESCRIPTION OF THE INVENTION—FIGS. 1 TO 14

The positioning of the four video cameras are illustrated in FIGS. 1, 2 and 3 (top view). A left-view video camera 1 or 7 is placed at the left side of a automobile. A right-view video camera 4 or 8 is placed at the right side of the automobile. The main part of the side-view (left-view and right-view) video cameras are covered by the body of the automobile. Since video cameras can be made very small, it is very easy to make it. When the automobile is turned on, the heads of the side-view cameras are exposed to the outside to catch scene. When the automobile is turned off, the side-view cameras are covered by the body. There are some options of positioning side-view cameras, such as camera 1 and 7, 4 and 8. A front-view video camera is placed near the top of the front wind-screen below the roof inside the automobile. A rear-view video camera is placed near the top of the rear wind-screen below the roof inside the automobile. The view angle depends on the characteristics of the video cameras that will be used.

The four video cameras are connected to the control unit 15. The control unit can be a computer with certain input and output ports for the video streams, the two control buttons and the light indicators. It can be also implemented by a hardware, such as a chip, to fulfill the functions required. The control unit accepts commands from two buttons, NIGHT button 11 and Front/Rear button 12. NIGHT button controls whether the control unit should operate at NIGHT enhancement mode or not and which transform function should be used for the enhancement if the button is pressed. The Front/Rear button controls whether the front-view camera 2 or rear-view camera 3 is turned on and the corresponding video stream is sent to the Front/Rear screen 18 in the display panel 16 when the automobile is started. If the button is pressed, the front-view camera is turned on and connected while the rear-view camera is turned off. If the button is not pressed, the rear-view camera is turned on and connected while the front-view camera is turned off. The left-view camera and right-view camera are always turned on and connected when the automobile is started. The control unit also turns the corresponding light indicator(s) 13 and/or 14 on if NIGHT button and/or Front/Rear button is(are) pressed. It always obtains video streams from left-view camera and right-view camera and send video streams to the left screen 17 and right screen 19 respectively.

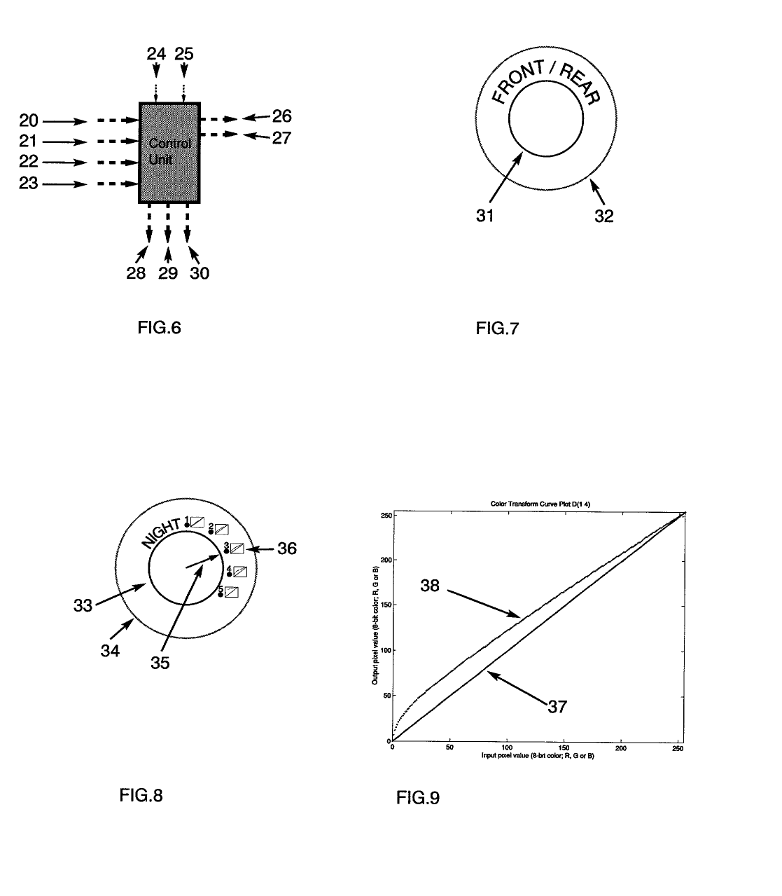

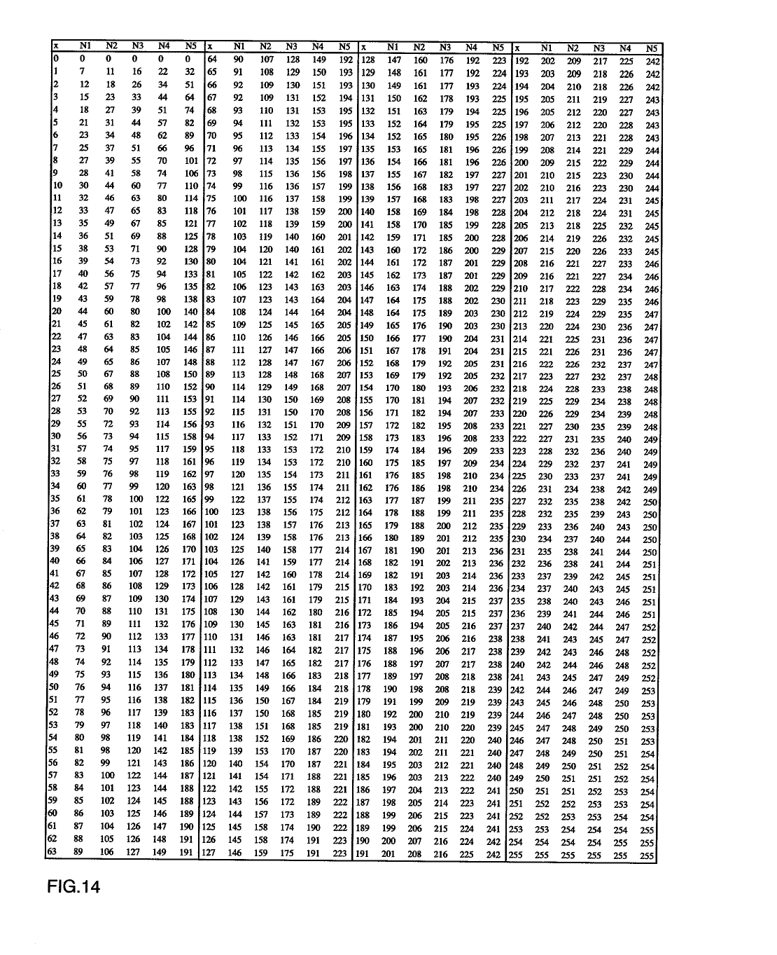

The control unit is the essential part of the system as shown in FIG. 6. There are four video input ports and two button control inputs to the Control Unit and there are three video output ports and two signal output ports from it. Each input port 20 21 22 or 23 receives video stream from one video camera 9 10 2 or 3 respectively. The video stream contains the video frames with RGB color information to each pixel in every frame. The control unit takes the RGB values as input parameter and use the transform function (or curve or table) to obtain output RGB values for each pixels, and then output the modified RGB values to the screens in the display panel. If the NIGHT button is not pressed, the control unit will just copy the input values and put them directly to the output. In this case, the screens will get the same pixel values as they are obtained from the video cameras. If the NIGHT button is pressed, the system will work in the enhancement mode (which will be explained later) and the control unit will identify which transform function is used. Then, the control unit will look up the table and find out the specific output pixel value for one specific input value. For each pixel, it would need to check R, G and B values individually and then do the transform or find the output pixel values from the transform table as shown in FIG. 14.

The two button control inputs 25 24 accept commands from Front/Rear control button and NIGHT button respectively. If the Front/Rear control button is pressed, the control unit will accept the video stream from the front-view camera for processing. If the button is not pressed, the control unit will accept the video stream from the Rear-view camera for processing. The Front-view video stream is needed in some situations. For example in the dark day or in the night when the outside is not clear, it is necessary to make use of NIGHT enhancement mode to help see dearly. It can also be used for further advanced features to be developed.

If the NIGHT button is pressed and a transform function is selected for the enhancement, the control unit will operate at enhancement mode. It will get RGB value for each pixel, looks up the selected table and finds the output RGB value for the pixel and send it out.

There are five levels of enhancement designed in this invention, each level have different enhancement strength. FIGS. 9 to 13 show the transform function curves of N1, N2, N3, N4 and N5 respectively. N1 has the smallest enhancement of the five and N5 has the largest enhancement of the five. In each figure, there is one curve and one straight line. The curve is the transform function curve and the straight line is the simulated function line which has no enhancement as a reference. From the function curves, they show that the functions give more gain to the dark pixels (close to 0) and compress the bright pixels (close to 255). We know that the black has RGB pixel value (0 0 0) and white has RGB pixel value (255 255 255) for 8-bit color. It is clear that N1 (FIG. 9) only enhances a little bit compared with the line without enhancement and N5 (FIG. 13) enhances a lot, especially near the dark region (close to 0).

If the NIGHT button is not pressed, the control unit will not do any transform and just send the input to the output.

The five output ports of the control unit contain two button-control monitoring outputs and three video streams output ports to the three screens on the display panel which will be placed somewhere behind the wheel.

The two button-control-monitoring outputs are Front/Rear button monitoring output 26 and NIGHT button monitoring output 27. Each monitoring output is connected to a light indicator, which is placed in the panel above the Front/Rear screen. If a button is pressed, the corresponding light indicator will be turned on, indicating that the specific button is pressed.

Each of the three video stream output ports sends the (enhanced) video stream to the corresponding screen in the display panel.

### SUMMARY

Accordingly, the reader will see that the use of video cameras as mirrors in an automobile of this invention is very attractive. It can be implemented in the automobile design very easily and conveniently. In addition, this invention has some advantages in that:

1. It solves the problem that impact the automobile body design due to the side-view mirrors. Without the burden of positioning side-view mirrors, designers can make full use of their idea in their design work. Since video cameras can be made very small, they won't impact the designs.

2. Without side-view mirrors, the automobile reduces its effective cross-section to the resistance of the air. It means that the gas cost will be less.

3. Since the screens in the display panel are placed behind the wheel and facing drivers, the drivers just watch the screen before them to see the conditions at the side of their automobiles without moving their heads. They don't need to turn their heads to see the side-view mirrors and have to have their eyes away from the driving direction where the automobiles are moving to. We all understand that the moment the drivers don't see the moving direction is dangerous.

4. The NIGHT enhancement mode could ease drivers' worries of night drives. The powerful functions can show very dark objects at night in the screens. It is believed that it will help drivers to drive more safely.

5. The transform functions of the NIGHT enhancement mode can be also developed to suit special interests and concerns.

6. The screen(s) in the display panel can be also used to show some useful data and information if the system is controlled by a computer, such as map, contact information and the conditions of the automobile.

7. The video cameras have larger view angle than that of mirrors so that drivers can see more areas and get more information around their automobiles.

Although the description above contains many specificities, these should not be construed as limiting the scope of the invention but merely providing illustrations of some of the presently preferred embodiments of this invention. For example, the transform functions of the NIGHT enhancement mode can be of some other features, such as more gain at both dark region (pixel value R, G or B near 0) and middle dark region (pixel value R, G or B around 100) and greatly compression at bright region (pixel value R, G or B near 255), etc.

Thus the scope of the invention should be determined by the appended claims and their legal equivalents, rather than by the examples given.

I claim:

1. In an Automobile-based Video System of the type comprising video cameras, a control unit, buttons and a display panel, the said system provides means to see conditions outside said automobile.

2. The system of claim 1 wherein a video camera for left-side view is placed at the left side of said automobile.

3. The system of claim 1 wherein a video camera for right-side view is placed at the right side of said automobile.

4. The system of claim 1 wherein a video camera for front view is placed behind the front wind-screen of said automobile.

5. The system of claim 1 wherein a video camera for rear view is placed behind the rear wind-screen of said automobile.

6. The system of claim 1 wherein said control unit has input and output ports and provides means of video inputs, video outputs, controls inputs and signal outputs.

7. The system of claim 6 wherein said control unit receives said video inputs from said video cameras.

7. The system of claim 6 wherein a Front/Rear button controls whether said video camera for front view or said video camera for rear view is turned on and connected to said control unit.

8. The system of claim 6 wherein a NIGHT button controls to turn on/off a NIGHT enhancement mode and selects one of transform function for said NIGHT enhancement mode.

9. The system of claim 6 wherein said control unit sends out signals to turn on a Front/Rear light indicator or a NIGHT light indicator in said display panel when said Front/Rear button or said NIGHT button is pressed.

10. The system of claim 6 wherein said control unit operates at said NIGHT enhancement mode to enhance dark scenes.

11. The system of claim 10 wherein said NIGHT enhancement mode transforms said video inputs into enhanced said video outputs to provide said NIGHT enhancement by said transform functions.

12. The system of claim 6 wherein said control unit sends said video outputs to screens in said display panel respectively.

13. The system of claim 6 wherein said control unit sends said video inputs to said video outputs directly without said NIGHT enhancement when said NIGHT button is not pressed.

14. The system of claim 6 wherein said control unit can be implemented by a computer, a hardware or a chip.

15. The system of claim 1 wherein said display panel comprises screens and light indicators.
